(19) United States
(12) Patent Application Publication
(10) Pub. No.: US 2019/0321891 A1
(43) Pub. Date: Oct. 24, 2019

(54) PROCESS FOR MANUFACTURING HIGH DENSITY ARTICLES FROM STAINLESS STEEL POWDER

(71) Applicants: Gary L. Anderson, St. Marys, PA (US); Zachary D'Aurora, Weedville, PA (US); Peter G. Imbrogno, Dubois, PA (US); Kevin A. Bauer, St. Marys, PA (US)

(72) Inventors: Gary L. Anderson, St. Marys, PA (US); Zachary D'Aurora, Weedville, PA (US); Peter G. Imbrogno, Dubois, PA (US); Kevin A. Bauer, St. Marys, PA (US)

(73) Assignee: Keystone Powdered Metal Company, St. Marys, PA (US)

(21) Appl. No.: 15/976,544

(22) Filed: May 10, 2018

Related U.S. Application Data
(60) Provisional application No. 62/507,482, filed on May 17, 2017.

(51) Int. Cl. B22F 5/08; B22F 3/10; F02P 7/067; H01F 41/02; H01F 1/22; G01P 3/481

(52) U.S. Cl. CPC B22F 5/08; B22F 3/10; F02P 7/0675; B22F 2301/35; H01F 1/22; G01P 3/481; B22F 2201/20; H01F 41/0246

(57) ABSTRACT

It has been found that high density articles having improved strength, corrosion resistance, better durability, and decent magnetic characteristics can be manufactured from a ferritic stainless steel powder using a novel method. This technique is especially beneficial in manufacturing parts, such as, reluctor rings, tone wheels, trigger wheels, pump impeller blades, and EGR valves, in large quantities. This method involves (1) compacting the ferritic stainless steel powder in a mold into a green article, (2) sintering the green article at an elevated temperature under vacuum or a reducing atmosphere to produce a sintered article, and (3) forging the sintered article under a reducing or an inert gas atmosphere to a density of greater than 7.5 g/cc in the presence of a graphite free lubricant to produce the high density article.

This application claims the benefit of U.S. Provisional Patent Application Ser. No. 62/507,482, filed on May 17, 2017. The teachings of U.S. Provisional Patent Application Ser. No. 62/507,482 are incorporated by reference herein in their entirety.

### BACKGROUND OF THE INVENTION

Powder metal parts can be produced in high volume at a cost which is lower than the cost of manufacturing the part via with wrought steel and subsequently machining or otherwise working the parts to desired dimensions. To attain better corrosion resistance and improved durability stainless steel powders are conventionally used in manufacturing parts for some applications. For instance, reluctor rings, tone wheels, and trigger wheels are frequently made with stainless steel powder. However, such parts are still susceptible to corrosion even though they are made with stainless steel powder. In any case, parts made with stainless steel powder using conventional techniques do not offer the physical properties, durability, and service life that is typically expected from stainless steel.

There is a need for stainless steel parts which offer corrosion resistance, decent magnetic properties and prolonged service life that can be manufactured in high volumes at a low manufacturing cost using powder metal technology. For instance, there is a demand for reluctor rings, tone wheels, trigger wheels, and a wide variety of other products which offer such improved characteristics.

### SUMMARY OF THE INVENTION

The subject invention relates to a method for manufacturing high density powder metal parts using ferritic stainless steel powder to achieve corrosion resistance, decent magnetic properties and prolonged service life. This technique involves (1) compacting the ferritic stainless steel powder in a mold into a green article, (2) sintering the green article at an elevated temperature under vacuum or a reducing atmosphere to produce a sintered article, and (3) forging the sintered article under a reducing or an inert gas atmosphere to a density of greater than 7.5 g/cc in the presence of a graphite free lubricant to produce the high density article. The graphite free lubricant can be a glass based forging lubricant or boron nitride.

The subject invention more specifically reveals a reluctor ring having improved strength, better corrosion resistance, better durability, and improved magnetic characteristics which is comprised of a wheel having an inside and an outside diameter, wherein a multitude of straight sided teeth are on the outside diameter of the wheel and wherein the reluctor ring is comprised of powder forged ferritic stainless steel having a density of at least 7.5 g/cc.

The present invention also discloses a tone wheel which is comprised of a body having a convex outer surface with a plurality of surface features arranged annularly thereon about a central axis and a concave inner surface, wherein the tone wheel is comprised of powder forged ferritic stainless steel having a density of at least 7.5 g/cc. The tone wheel can optionally include a plurality of annular flanges which extend inwardly from the inner surface toward the central axis, wherein each flange has a mating surface for contacting a carrier with the mating surface being axially offset from the inner surface of the body.

The subject invention further reveals a powder forged ferritic stainless steel part which is comprised of powder forged ferritic stainless steel which includes a performance enhancing agent. For instance, the performance enhancing agent can be a solid internal lubricant, such as molybdenum disulfide, or wear resistant particles, such as glass particles or ceramic particles.

### SUMMARY OF THE DRAWINGS

FIG. 1 illustrates a reluctor ring which is comprised of a wheel having an inside and an outside diameter, wherein a multitude of straight sided teeth are on the outside diameter of the wheel. Reluctor rings of this type are widely used in automotive antiskid braking systems and can be manufactured in accordance with the technique of this invention.

FIG. 2 illustrates a second type of reluctor ring which is also widely used in automotive applications and which can be manufactured in accordance with the technique of this invention. This type of reluctor ring is comprised of two wheels of the same diameter which are attached together with a plurality of ribs which extend between the wheels.

### DETAILED DESCRIPTION OF THE INVENTION

Powder metal articles are manufactured utilizing the process of this invention by placing a ferritic stainless steel metal powder composition into a mold and subsequently compacting the metal powder in the mold under a high pressure which is typically within the range of 20 tsi to 70 tsi (tons per square inch). This results in the formation of an uncured or green metal part. The green part is then cured or sintered in the solid state by heating it in a sintering furnace, such as an electric or gas-fired belt or batch sintering furnace, for a predetermined time at high temperature under vacuum or in a reducing atmosphere. Hydrogen and endothermic gases are examples of suitable reducing atmospheres. This sintering results in the metal particles of the part bonding together by diffusion rather than by melting and re-solidification.

A variety of stainless steel powders can be utilized in the practice of this invention. For instance, ferritic 400 series alloy stainless steels can be beneficially used. Some representative examples of stainless steel powders that can be used include those having the following material designations: SS-409L; SS-409LE; SS-409LNi; SS-410L; SS-430N2; SS-430L; SS-434N2; SS-434L; and SS-434LCb.

The sintering temperature utilized will typically be about 60% to about 90% of the melting point of the stainless steel composition being utilized. The sintering temperature will normally be in the range of 1500° F. (816° C.) to 2450° F. (1343° C.). The sintering temperature for iron based compacts will more typically be within the range of 2000° F. (1093° C.) to about 2400° F. (1316° C.). In any case, the appropriate sintering temperature and time-at-temperature will depend on several factors, including the chemistry of the stainless steel metallurgical powder, the size and geometry of the compact, and the heating equipment used. Those of ordinary skill in the art will be able to readily determine appropriate parameters for the molding steps to provide a green preform of suitable density and geometry.

The part being made (article of manufacture) will typically be maintained at the sintering temperature for a period which is within the range of 15 minutes to 8 hours or longer and will more typically be maintained at the sintering temperature for a period of 20 minutes to 2 hours under the protective atmosphere to adequately sinter the metal in the article. In many cases it is optimal to maintain the green metal part at the elevated sintering temperature for a period of 45 minutes. In any case, the part will be sintered for a period of time which is adequate to attain the desired level of bonding.

The final density of the part will vary depending on its composition and the particular pressing and sintering parameters employed. The average density of a green preform formed from an iron-base metallurgical powder typically is in the range of 6.2 to 7.2 g/cc and may be, for example, 6.8 g/cc. The density of the part can also be expressed as a percentage of the theoretical density of the composition.

The sintered article is then forged under a reducing or an inert gas atmosphere to a density of greater than 7.5 g/cc in the presence of a graphite free lubricant to produce the high density article. Hydrogen gas and endothermic gases are representative examples of reducing gases under which the part can be forged. Nobel gases, such as helium, neon, and argon, are examples of suitable inert gases under which the part can be forged. Some representative examples of graphite free lubricants that can be used include glass based forging lubricants, ethylene bissteramide, and boron nitride. In cases where boron nitride is utilized as the graphite free lubricant, it will be in the hexagonal form and will typically have a density of about 2.1 g/cm³. The graphite free lubricant will typically be included in the stainless steel metal powder at a level which is within the range of 0.2 to 1 weight percent, based upon the total weight of the stainless steel powder composition.

It is desirable for the article to be forged to the highest density which is commercially viable. For instance, it is desirable for the final article to have a final density of at least 7.6 g/cc. It is preferred for the finished part to have a density greater than 7.7 g/cc and it is more preferred for the finished part to have a density greater than 7.75 g/cc. It is optimal for the finished part to be forged to essentially theoretical density.

The technique of this invention can be used in manufacturing a wide variety of products which offer corrosion resistance, decent magnetic properties and prolonged service life. For example, the technique of this invention can be employed in manufacturing reluctor rings, tone wheels, trigger wheels, pump impeller blades, and EGR valves, in large quantities at relatively low cost.

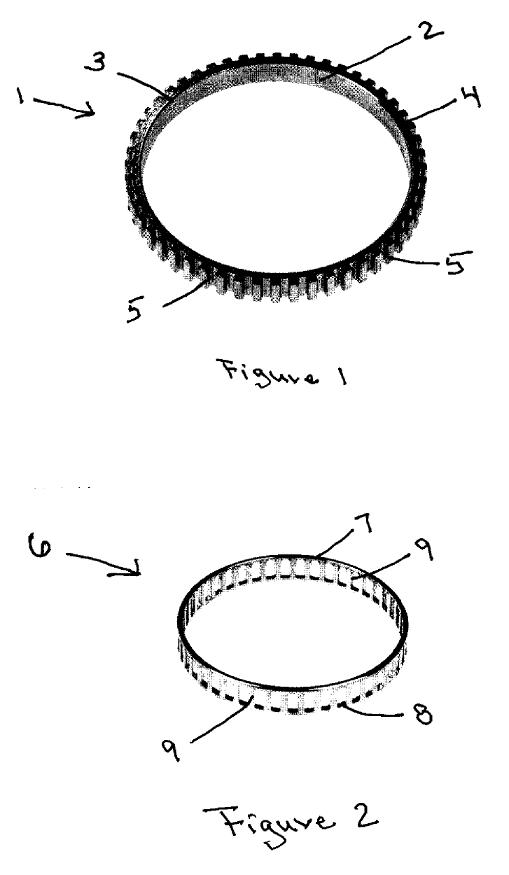

A reluctor ring is a notched wheel used in the anti-lock brake systems (ABS) and the ignition system of cars, trucks, and aircraft. Such a reluctor ring is illustrated in FIG. 1. This reluctor ring 1 is comprised of a wheel 2 having an inside diameter 3 and an outside diameter 4, wherein a multitude of straight sided teeth 5 are on the outside diameter 4 of the wheel 1. Anti-lock brake reluctor rings are located on each wheel of the vehicle and are an essential part of the speed-sensing apparatus used to determine the rate at which the wheel is turning.

FIG. 2 illustrates a second type of reluctor ring which is also widely used in automotive applications and which can be manufactured in accordance with the technique of this invention. This type of reluctor ring 6 is comprised of a first wheel 7 and a second wheel 8 which are of the same diameter and which are attached together with a plurality of ribs 9 which extend between the wheels.

In distributor-less ignition systems and direct-ignition systems a reluctor ring is mounted on the crankshaft of the engine and acts as the trigger for a magnetic sensor. In any case ignition reluctor rings combine evenly and/or unevenly spaced notches that send information to the electronic control module in order to control ignition timing. The reluctor ring is typically attached to the crankshaft for the purpose of controlling cylinder timing. In conventional automotive engines, the reluctor ring provides information about the rotational position and speed of the crankshaft in order to signal the need and/or timing of a spark in appropriate cylinders (i.e. to control the firing of the spark plugs in the cylinders of the engine). In such electronic ignition systems the current of a sensor circuit, in conjunction with the reluctor ring, is intermittently broken by the teeth rotating on the crankshaft mounted reluctor ring. This, in turn, provides the necessary information for correctly timed cylinder ignition. In any case, the reluctor ring is used in conjunction with magnetic pickup sensors, hall effect sensors, or optical sensors. A system for controlling engine timing that utilized such a reluctor ring and pickup sensors is described in U.S. Pat. No. 8,826,886. The teachings of U.S. Pat. No. 8,826,886 are incorporated herein for the purpose of describing such reluctor rings and electronic ignition systems that utilize such reluctor rings.

U.S. Pat. No. 9,594,090 describes a tone wheel for a speed-sensing apparatus. This tone wheel is comprised of a body having a convex outer surface with a plurality of surface features arranged annularly thereon about a central axis, a concave inner surface, and a plurality of annular flanges extending inward from the inner surface toward the central axis, each flange having a mating surface for contacting a carrier, the mating surface being axially offset from the inner surface of the body. The body of the tone wheel can include a number of pairs of the flanges, wherein the flanges of each pair extend toward one another. The annular flanges of the tone wheel provide an interference fit with the carrier. The flanges are described as being flexible relative to a body of the tone wheel such that the flanges provide an interference fit with a carrier of a planetary gearset of the carrier. The teachings of U.S. Pat. No. 9,594,090 are incorporated herein by reference for the purpose of describing such tone wheels. A tone wheel for automotive applications is also illustrated in U.S. Pat. No. 9,594,090. The teachings of U.S. Pat. No. 9,594,090 are also incorporated herein by reference for the purpose of teaching such a tone wheel.

While certain representative embodiments and details have been shown for the purpose of illustrating the subject invention, it will be apparent to those skilled in this art that various changes and modifications can be made therein without departing from the scope of the subject invention.

What is claimed is:

1. A method for making a high density article from ferritic stainless steel powder wherein said article has good corrosion resistance, higher strength, and decent magnetic properties, said method comprising (1) compacting the ferritic stainless steel powder in a mold into a green article, (2) sintering the green article at an elevated temperature under vacuum or a reducing atmosphere to produce a sintered article, and (3) forging the sintered article under a reducing or an inert gas atmosphere to a density of greater than 7.5 g/cc in the presence of a graphite free lubricant to produce the high density article.

2. The method of claim 1 wherein the lubricant is a glass based forging lubricant.

3. The method of claim 1 wherein the lubricant is boron nitride.

4. The method of claim 1 wherein the reducing gas is hydrogen.

5. The method of claim 1 wherein the inert gas is a Nobel gas selected from the group consisting of helium, neon, and argon.

6. The method of claim 3 wherein the boron nitride is in hexagonal form and a density of about 2.1 g/cm³.

7. The method of claim 1 wherein the sintering step is carried out under vacuum.

8. A reluctor ring having improved strength, good corrosion resistance, better durability, and decent magnetic characteristics which is comprised of a wheel having an inside and an outside diameter, wherein a multitude of straight sided teeth are on the outside diameter of the wheel and wherein the reluctor ring is comprised of powder forged ferritic stainless steel having a density of at least 7.5 g/cc.

9. The reluctor ring of claim 8 wherein the reluctor ring is adapted for use in a sensor system for an antilock brake system.

10. The reluctor ring of claim 8 wherein the reluctor ring is adapted for use in a distributor-less ignition system.

11. A tone wheel which is comprised of a body having a convex outer surface with a plurality of surface features arranged annularly thereon about a central axis and a concave inner surface, wherein the tone wheel is comprised of powder forged ferritic stainless steel having a density of at least 7.5 g/cc.

12. The tone wheel of claim 11 wherein the tone wheel includes a plurality of annular flanges which extend inwardly from the inner surface toward the central axis.

13. The tone wheel of claim 12 wherein each flange has a mating surface for contacting a carrier with the mating surface being axially offset from the inner surface of the body.

14. The tone wheel of claim 13 wherein the surface features are ribs.

15. The tone wheel of claim 13 wherein the surface features are ridges.

16. The tone wheel of claim 13 wherein the surface features are raised strips.

17. A powder forged ferritic stainless steel part which is comprised of powder forged ferritic stainless steel which includes a performance enhancing agent selected from the group consisting of solid internal lubricants and wear resistant particles.

18. The part as specified in claim 17 wherein the solid internal lubricant is molybdenum disulfide and wherein the wear resistant particles are glass particles or ceramic particles.

19. The powder forged ferritic stainless steel part of claim 17 wherein the part is trigger wheel.

20. The powder forged ferritic stainless steel part of claim 17 wherein the part is pump impeller blade.
